(19) United States
(12) Patent Application Publication
(10) Pub. No.: US 2025/0021058 A1
(43) Pub. Date: Jan. 16, 2025

(54) METHOD AND ASSEMBLY FOR MONITORING OR CONTROLLING A MACHINE

(71) Applicant: Siemens Aktiengesellschaft, München (DE)

(72) Inventors: Birgit Obst, München (DE); Jan Fischer, München (DE); Wolfram Klein, Neubiberg (DE); Roland Rosen, Seefeld (DE); Moritz Allmaras, Seefeld (DE); Daniel Klein, Kastl (DE); Franz Georg Listl, Pettendorf (DE); Nils Weinert, München (DE)

(21) Appl. No.: 18/711,788

(22) PCT Filed: Nov. 10, 2022
(86) PCT No.: PCT/EP2022/081515

§ 371 Date: May 20, 2024

(30) Foreign Application Priority Data
Nov. 24, 2021 (EP) 21210218.0

(51) Int. Cl. G05B 1/03; G05B 13/04

(52) U.S. Cl. CPC G05B 1/03; G05B 13/04

(57) ABSTRACT

To monitor or control a machine, current operating signals are captured continuously, and a current operating state is measured continuously. On the basis of the captured operating, a simulated operating state is determined continuously by a concurrent simulator. In addition, upon detection of a difference between the simulated operating state and the measured operating state, a difference pattern that quantifies the deviation or a change in the measured operating state is compared with a plurality of specified difference types which are characteristic of a modification of the machine or a machine operation, and each of the difference types is assigned a difference-type-specific simulator variant. Depending on the result of the comparison, one of the difference types is then selected. On the basis of the simulator variant assigned to the selected deviation type, the concurrent simulator is adapted, and the machine is monitored or controlled using the adapted concurrent simulator.

### CROSS-REFERENCE TO RELATED APPLICATIONS

This application is a national stage of PCT Application No. PCT/EP2022/081515, having a filing date of Nov. 10, 2022, claiming priority to EP application Ser. No. 21/210,218.0, having a filing date of Nov. 24, 2021, the entire both contents of which are hereby incorporated by reference.

### FIELD OF TECHNOLOGY

The following relates to a method and assembly for monitoring or controlling a machine.

### BACKGROUND

Complex machines, e.g., robots, motors, production plants, machine tools, turbines, internal combustion engines or motor vehicles, generally require complex control and monitoring methods for productive and stable operation. For this purpose, use is increasingly made of simulation methods that simulate a physical response of the machine to be controlled. Efforts are often made to provide a so-called digital twin of the machine, or at least for one component of the machine, which simulates a response of the machine in parallel with ongoing operation of the machine. To this end, the digital twin is continually supplied with present operating signals of the machine that are used to synchronize the concurrent simulation with actual machine operation.

Such a digital twin can be used to ascertain operating data of the machine that would otherwise not be measurable, or would be measurable only with difficulty. In addition, a future operating response of the machine can be predicted by simulation in many cases. The operating data ascertained by simulation can then be used in addition to directly measurable operating data to control or monitor the machine in an optimized and/or predictive manner. As such, in a production plant, for example, the threat of material bottlenecks can be recognized or operational sequences can be optimized. Similarly, an internal temperature of a winding of an electric motor, which is directly measurable only with difficulty, can be ascertained by simulation in order to output a warning signal or to automatically regulate the electric motor if a limit value is exceeded.

It is to be expected that the machine will be able to be controlled or monitored all the more efficiently the more accurately a concurrent simulation can replicate an actual response of the machine. During real operation of a machine, changes are meanwhile frequently made that place high demands on the flexibility of a simulator operating concurrently in real time. This applies in particular to production plants in which machine components are frequently replaced or specifications of a product to be manufactured are frequently changed. An accordingly flexible and therefore detailed simulator generally necessitates a high level of complexity and/or considerable computing resources, however, which in many cases are hard to provide in real time.

### SUMMARY

An aspect relates to a method and an assembly for monitoring or controlling a machine that is able to be used more flexibly.

A machine is monitored or controlled by continually recording present operating signals of the machine and measuring a present operating state of the machine during operation of the machine. The machine in this instance may be in particular in the form of a robot, a motor, a production plant, a machine tool, a turbine, an internal combustion engine and/or a motor vehicle. On the basis of the recorded operating signals, a concurrent simulator continually ascertains a simulated operating state of the machine. Furthermore, detection of a difference between the simulated operating state and the measured operating state results in a difference pattern, which quantifies the difference or a change in the measured operating state, being compared with multiple predefined difference types that are characteristic of a modification of the machine or of machine operation and that each have an assigned difference-type-specific simulator variant. The comparison result is then taken as a basis for selecting one of the difference types. The simulator variant assigned to the selected difference type is taken as a basis for adapting the concurrent simulator, and the adapted concurrent simulator is used to monitor or control the machine.

To carry out the method according to embodiments of the invention, there is provision for an assembly according to embodiments of the invention, a computer program product (non-transitory computer readable storage medium having instructions, which when executed by a processor, perform actions) and a computer-readable, for example nonvolatile, storage medium.

In embodiments, the method and the assembly can be carried out and implemented for example by one or more computers, processors, application-specific integrated circuits (ASICs), digital signal processors (DSPs) and/or so-called “field programmable gate arrays” (FPGAs). In addition, at least part of the method according to embodiments of the invention can be carried out in a cloud.

An embodiment of the invention can be seen in particular in that a large number of changes in the machine or in machine operation can be automatically detected and the concurrent simulation can be adapted accordingly. It is in particular not necessary for the concurrent simulator to replicate all possible changes in the machine or in machine operation in advance. Many change phenomena therefore no longer require manual intervention in ongoing operation of the machine or in the simulation.

According to an embodiment of the invention, the predefined difference types may each have one or more assigned reference patterns. A respectively ascertained difference pattern can be compared with the reference patterns, a measure of similarity being ascertained in each case. The difference type can then be selected on the basis of the ascertained measures of similarity. In embodiments, a threshold value for the measure of similarity can be predefined, the exceeding or underrunning of which results in a difference type assigned to the relevant reference pattern being selected. A measure of similarity can be ascertained using known similarity metrics, for example a Jaccard similarity metric, a Braun similarity metric and/or a phi similarity metric.

In embodiments, there may be provision for reference patterns that are characteristic of a replacement of machine components, of structural, topological and/or functional modifications of the machine, of a change of product in the case of a production plant, of a change in a user behavior or a work schedule, of maintenance work and/or of a change in a configuration of the machine. The above changes in the machine or in machine operation occur frequently in practice and have required manual adjustment of the concurrent simulation and/or interruption of ongoing machine operation in many cases to date. In embodiments, the method according to embodiments of the invention can often be used to avoid or at least substantially reduce manual interventions of this kind.

According to an embodiment of the invention, the ascertained difference pattern can be compared with a respective difference type by using the simulator variant assigned to the respective difference type to ascertain a further simulated operating state. The further simulated operating state can then be compared with the measured operating state, and the difference type can be selected on the basis of the comparison result. In embodiments, that difference type whose assigned simulator variant ascertains the further simulated operating state that best matches the measured operating state can be selected. In embodiments, a further simulated operating state can be ascertained by instantiating and executing an instance of the assigned simulator variant.

According to an embodiment of the invention, the ascertained difference patterns can be stored in a database, in particular as reference patterns for the selected difference type. The stored difference patterns can then be taken into consideration for a subsequent selection of the difference type. In this way, the predefined difference types can be enriched during operation with difference patterns that really occur, or recognition thereof can be refined.

According to an embodiment of the invention, a respectively predefined difference type can be assigned an item of cause information about a difference-causing machine component. The concurrent simulator can then be adapted in a manner specific to the machine component on the basis of the cause information assigned to the selected difference type. Insofar as many simulation models have a component-specific orientation, the concurrent simulator can be more accurately adjusted for altered operating conditions in many cases on the basis of such cause information.

Furthermore, a respectively predefined difference type can be assigned a variant of the machine. The concurrent simulator can then be adapted in a manner specific to the machine variant on the basis of the variant of the machine assigned to the selected difference type. The machine variants provided may be in particular a predecessor and/or a successor of/to the current machine. As such, detection of a difference pattern that is characteristic of a successor can result in the concurrent simulator being automatically adjusted for the successor.

According to an embodiment of the invention, the difference types and/or the assigned simulator variants can be semantically specified by a knowledge graph. In embodiments, the knowledge graph can also assign a reference pattern, an item of cause information and/or a machine variant and also optionally the semantic description thereof to a respective difference type. Such knowledge graphs can be used to organize the associations or descriptions efficiently and across applications.

According to an embodiment of the invention, a sensitivity of a respective operating state to a respective operating signal can be ascertained, for example in advance. The ascertained sensitivities can be taken as a basis for selecting a group of operating states, to which detection of the difference is then limited. In this way, the number of operating states to be monitored can be reduced in many cases without there being a significant reduction in the quality of the simulation.

### BRIEF DESCRIPTION

Some of the embodiments will be described in detail, with references to the following Figures, wherein the designations denote like members, wherein:

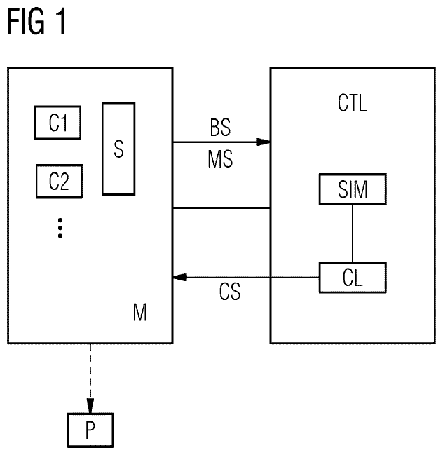

FIG. 1 illustrates a machine having a control device according to embodiments of the invention; and

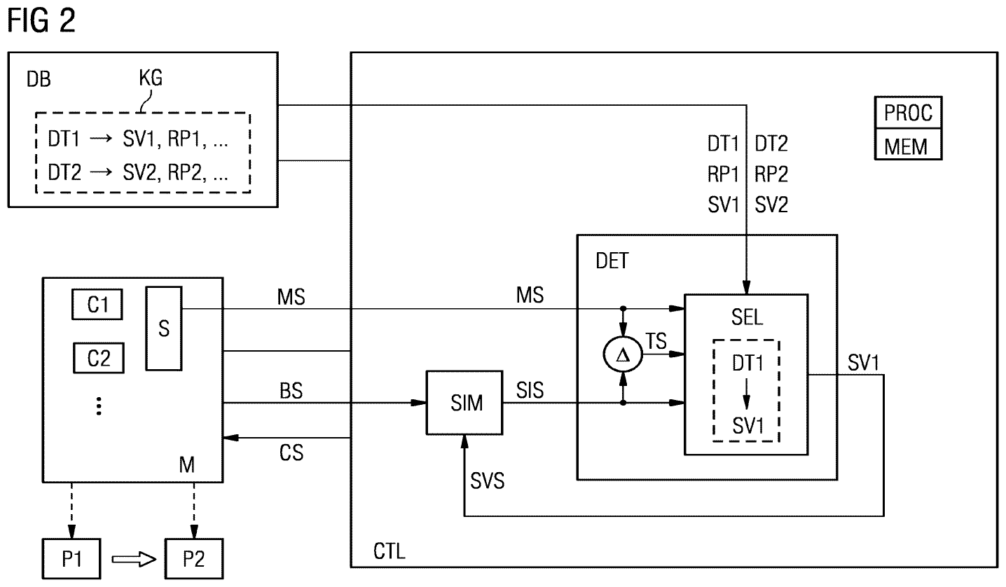

FIG. 2 illustrates the control device in a more detailed representation.

### DETAILED DESCRIPTION

FIG. 1 illustrates a machine M having a control device CTL according to embodiments of the invention, which is coupled to the machine M, for monitoring and/or controlling the machine M. The machine M may be in particular a robot, a motor, a production plant, a machine tool, a turbine, an internal combustion engine and/or a motor vehicle or may comprise such a machine. For the present exemplary embodiment, it will be assumed that the machine M is a production plant for manufacturing a product P.

The machine M has multiple machine components C1, C2, . . . , which, in the case of a production plant, may be in particular individual machine tools, robots, conveyor belts or other plant parts, plant components or production resources. For reasons of clarity, FIG. 1 shows only two machine components C1 and C2 explicitly.

The control device CTL is shown externally to the machine M in FIG. 1. Alternatively, the control device CTL may also be wholly or partially integrated in the machine M.

The machine M and/or its components C1, C2, . . . have a sensor system S for continually measuring present operating states MS of the machine M. The operating states MS recorded can be in particular sensor data from the sensor system S or state data or measured values derived therefrom that quantify a performance, a rotational speed, a torque, a material flow, a position of workpieces within a processing sequence, a machining condition of workpieces, a speed of movement, an exerted or acting force, a temperature, a pressure, a present resource consumption, available resources, pollutant emissions, vibrations, a wear and/or a load on the machine M or components of the machine M, in particular over the course of time. The measured operating states MS are continually transmitted from the machine M to the control device CTL.

Furthermore, the control device CTL continually records present control-related operating signals BS of the machine M. The operating signals BS may also comprise one or more of the measured operating states MS wholly or in part. In addition, the operating signals BS may comprise present manipulated variables, manipulated values, control parameters, controlled variables, environmental data, monitoring signals, diagnostic signals and/or error signals of the machine M or from the components C1, C2, . . . thereof. The operating signals BS are continually transmitted from the machine M to the control device CTL.

The control device CTL furthermore has a concurrent simulator SIM, which in the present exemplary embodiment is implemented as a so-called digital twin of the machine M. The concurrent simulator SIM performs a real-time simulation of the machine M or of one or more of its components C1, C2, . . . in parallel with ongoing operation of the machine M.

For this purpose, the concurrent simulator SIM is supplied with the operating signals BS. On the basis of the supplied operating signals BS, the concurrent simulator SIM simulates a present operating response of the machine M, or of one or more of its components C1, C2, The simulated operating response is used to continually ascertain simulated operating states of the machine M. In embodiments, simulated operating states of the machine M that would otherwise be measurable or analyzable only with difficulty, e.g., impending bottlenecks in the procedure and/or an internal temperature or a force distribution within moving components, are ascertained in this manner.

To implement the concurrent simulator SIM, there are many known methods for physical or logistical simulation available, in particular material flow models, production sequence models and/or mechanical, electrical or thermal simulation models and also efficient finite element methods.

At least some of the operating signals BS, the measured operating states MS and the simulated operating states are fed into control logic CL of the control device CTL. On the basis of the operating signals BS, the measured operating states MS and the simulated operating states that are fed in, the control logic CL generates control signals CS that are transmitted to the machine M in order to control it. In addition, the control logic CL can also output monitoring signals for monitoring the machine M. The monitoring signal that is output can be for example an alarm signal, an operating recommendation, an error signal, a diagnostic signal and/or a maintenance signal.

FIG. 2 illustrates the control device CTL in a more detailed representation.

The control device CTL has one or more processors PROC for performing the method steps of embodiments of the invention and has one or more memories MEM for storing data to be processed.

As already mentioned above, the control device CTL has a concurrent simulator SIM that, during operation of the machine M, is continually supplied with present operating signals BS of the machine M. On the basis of the transmitted operating signals BS, the concurrent simulator SIM simulates a present operating response of the machine M or of at least one machine component in real time. In this way, the concurrent simulator SIM continually ascertains one or more present simulated operating states SIS of the machine M in parallel with ongoing operation of the machine M.

During operation, as described above, the control device CTL furthermore records present measured operating states MS of the machine M in the form of sensor data from the sensor system S or in the form of data derived therefrom. The measured operating states MS can be optionally preprocessed, transformed or filtered over time by the control device CTL, e.g., in order to recognize and optionally separately deal with outliers in the measured values.

The simulated operating states SIS ascertained by the concurrent simulator SIM are supposed to include in particular also operating variables that the measured operating states MS contain. The simulated operating states SIS ascertained by the concurrent simulator SIM can thus be e.g., a performance, a rotational speed, a torque, a material flow, a position of workpieces within a processing sequence, a machining condition of workpieces, a speed of movement, an exerted or acting force, a temperature, a pressure, available resources, a resource consumption, pollutant emissions, vibrations, a wear and/or a load on the machine M or its machine components, in particular over the course of time.

The simulated operating states SIS and the measured and optionally transformed operating states MS are fed into a difference detector DET of the control device CTL. The difference detector DET continually compares the simulated operating states SIS with the measured operating states MS and checks whether and/or to what extent a respective simulated operating state SIS differs from a corresponding measured operating state MS.

In embodiments the operating states SIS and MS to be compared can for example be selected in advance by a sensitivity analysis. This involves ascertaining which operating states affect an operating response of the machine M more greatly and which ones affect it less. This allows a group of operating states to be selected that have a particularly great, deterministic or characteristic effect on the operating response. The above-described comparison in the difference detector DET can then be limited to the group of selected operating states. To perform such a sensitivity analysis, there are a large number of known numerical methods available.

The comparison result ascertained by the difference detector DET is a numerical difference between the simulated operating states SIS and the measured operating states MS. A respective difference can be ascertained here for example in the form of one or more optionally weighted Euclidean distances between vector representations of the simulated operating states SIS and vector representations of the measured operating states MS.

Detection of a difference results in the difference detector DET generating a trigger signal TS. The trigger signal TS can be generated in particular when an ascertained distance exceeds a predefined threshold value.

The trigger signal TS prompts a selection device SEL of the difference detector DET to ascertain a difference pattern and to compare the difference pattern with multiple predefined different types. The difference pattern quantifies and characterizes the difference between the simulated operating states SIS and the measured operating states MS and/or a change in the measured operating states MS, in particular over the course of time. A respective change pattern can comprise e.g., one or more time series of changes in the measured operating states MS and/or one or more time series of differences from the simulated operating states SIS.

Embodiments of the invention attempt to assign the ascertained difference pattern to a predefined difference type DT1 or DT2, which is characteristic of a modification of the machine M or a modification of operation of the machine M, respectively.

The predefined difference types DT1 and DT2 are stored in a knowledge graph KG in a database DB coupled to the control device CTL. The knowledge graph KG contains, for a respective difference type DT1 or DT2, an assigned difference-type-specific simulator variant SV1 or SV2, at least one assigned difference-type-specific reference pattern RP1 or RP2 and an assigned item of cause information about a difference-causing machine component. In addition, the knowledge graph KG contains a semantic description of the difference types DT1 and DT2, the simulator variants SV1 and SV2, the reference patterns RP1 and RP2 and/or the respectively assigned cause information.

For reasons of clarity, FIG. 2 shows only two difference types DT1 and DT2 explicitly. Insofar as there may be provision for a multiplicity of modifications of the machine M or of machine operation, a multiplicity of further modification-specific difference types may be stored in the knowledge graph KG.

The reference patterns RP1 and RP2 stored in the knowledge graph KG are specific difference patterns that are characteristic of a respective difference type DT1 or DT2 and therefore of a specific modification of the machine M or of machine operation. Such reference patterns can be ascertained for example from historical operating data of the machine M or of similar machines. In embodiments, following assignment to a relevant difference type, the difference patterns ascertained during operation of the machine M can for example also be assigned to this difference type in the knowledge graph KG as a further reference pattern.

In embodiments, the knowledge graph KG can be used to store reference patterns that are characteristic of a replacement of machine components, of structural topological and/or functional modifications of the machine M, of a change of product in the case of a production plant, of a change in a user behavior or a work schedule, of maintenance work and/or of a change in a configuration of the machine M.

Accordingly, each of the difference-type-specific simulator variants SV1 and SV2 stored in the knowledge graph KG may be a simulator component, a parameterization and/or a configuration for the concurrent simulator SIM that are relevant to a simulation of the modified machine M or of modified machine operation. As such, a replacement of a first machine component with a second machine component can be replicated in the concurrent simulator SIM by replacing a first simulator component, which is responsible for simulating the first machine component, with a second simulator component, which is responsible for simulating the second machine component.

For the present exemplary embodiment, it will be assumed that the modification of the production plant M and its operation comprises a reorientation of the production plant M from manufacture of a first version P1 of a product to manufacture of a second version P2 of the product. By way of example, such a modification may be characterized by changes in machining trajectories, a change of machining tools, a change of materials, altered forces or other structural, topological or process-engineering changes.

In embodiments, characteristic changes such as these can for example be logged for earlier changes of product in the production plant M or a similar machine and stored in the knowledge graph KG in association with a difference type that is characteristic of the change of product.

It will be assumed for the present exemplary embodiment that the difference type DT1 is characteristic of the aforementioned change of product. Accordingly, the difference type DT1 in the knowledge graph KG has an assigned reference pattern RP1 that is characteristic of the change of product, an assigned item of cause information that specifies the change of product and an assigned simulator variant SV1 that is qualified to simulate the change of product or to manufacture the product version P2. To simulate such changes of product, a large number of suitable simulation methods are already available today.

A difference type relevant to the ascertained difference pattern is assigned or selected by supplying the selection device SEL with the difference type DT1 having the assigned reference pattern RP1 and the assigned simulator variant SV1 and with the difference type DT2 having the assigned reference pattern RP2 and the assigned simulator variant SV2.

In addition, the simulated operating states SIS, the measured operating states MS and the trigger signal TS are fed into the selection device SEL. As already mentioned above, the selection device SEL is prompted by the trigger signal TS to take the measured operating states MS and the simulated operating states SIS as a basis for ascertaining a difference pattern and comparing the latter with all of the different types, here DT1 and DT2.

In the present exemplary embodiment, the comparison is performed by comparing the difference pattern with the reference patterns RP1 and RP2, a measure of similarity being ascertained in each case. Such a measure of similarity can be calculated using various similarity metrics, e.g., a Jaccard similarity metric, a Braun similarity metric and/or a phi similarity metric. In embodiments, the measure of similarity ascertained can be a Euclidean distance between representative vectors of the variables that are to be compared.

The selected result of the comparison is that reference pattern, here RP1, that is most similar to the ascertained difference pattern; that is to say e.g., that reference pattern that is at the shortest Euclidean distance from the difference pattern. The most similar reference pattern RP1 is taken as a basis for selecting the assigned difference type, here DT1, as the difference type relevant to the ascertained difference pattern. The selected difference type DT1 is furthermore taken as a basis for selecting the simulator variant SV1 assigned to the selected difference type DT1 in the knowledge graph KG as the relevant simulator variant.

The selected simulator variant SV1 is transmitted from the selection device SEL to the concurrent simulator SIM in order to adapt the simulator for the change of product or for the new product version P2.

By way of example, the concurrent simulator SIM can be adapted by adding parameters or model components of the selected simulator variant SV1 to the concurrent simulator SIM or by modifying or substituting parameters or model components of the concurrent simulator SIM.

As already mentioned above, the adapted simulator SIM is also used during operation of the machine M to monitor the machine M in real time or to control it with control signals CS. In the manner according to embodiments of the invention, changes in the machine M or in machine operation can be automatically recognized and can prompt automatic adaptation of the concurrent simulator SIM. It is in particular not necessary for the concurrent simulator SIM to replicate all possible changes in the machine M or in machine operation in advance. Instead, a library of change phenomena, here in the form of the knowledge graph KG, with assigned change-specific simulator variants is, to a certain extent, accessed and the concurrent simulator SIM is adapted in a manner specific to the type of change. In this way, the detection of changes can be decoupled from the simulation itself to a certain degree. Many change phenomena therefore no longer require manual intervention in the simulation of ongoing operation of the machine M.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer-implemented method for monitoring or controlling a machine, wherein during operation of the machine
a) present operating signals of the machine are continually recorded and a present operating state of the machine is continually measured,
b) a concurrent simulator takes the recorded operating signals as a basis for continually ascertaining a simulated operating state of the machine,
c) detection of a difference between the simulated operating state and the measured operating state results in a difference pattern, which quantifies the difference or a change in the measured operating state, being compared with multiple predefined difference types that are characteristic of a modification of the machine or of machine operation and that each have an assigned difference-type-specific simulator variant,
d) the comparison result is taken as a basis for selecting one of the difference types,
e) the concurrent simulator is adapted on the basis of the simulator variant assigned to the selected difference type, and
f) the machine is monitored or controlled by the adapted concurrent simulator.

2. The method as claimed in claim 1, wherein,
the predefined difference types each have one or more assigned reference patterns,
a respectively ascertained difference pattern is compared with the reference patterns, a measure of similarity being ascertained in each case, and
the difference type is selected on the basis of the ascertained measures of similarity.

3. The method as claimed in claim 2, wherein a respectively predefined difference type has one or more assigned reference patterns that are characteristic
of a replacement of machine components,
of structural, topological and/or functional modifications of the machine,
of a change of product in the case of a production plant,
of a change in a user behavior or a work schedule,
of maintenance work and/or
of a change in a configuration of the machine.

4. The method as claimed in claim 1, wherein
the ascertained difference pattern is compared with a respective difference type by
using the simulator variant assigned to the respective difference type to ascertain a further simulated operating state,
comparing the further simulated operating state with the measured operating state, and
selecting the difference type on the basis of the comparison result.

5. The method as claimed in claim 1, wherein,
the ascertained difference patterns are stored in a database, and
the stored difference patterns are taken into consideration for a subsequent selection of the difference type.

6. The method as claimed in claim 1, wherein,
a respectively predefined difference type has an assigned item of cause information about a difference-causing machine component, and
the concurrent simulator is adapted in a manner specific to the machine component on the basis of the cause information assigned to the selected difference type.

7. The method as claimed in claim 1, wherein,
a respectively predefined difference type has an assigned variant of the machine, and
the concurrent simulator is adapted in a manner specific to the machine variant on the basis of the variant of the machine assigned to the selected difference type.

8. The method as claimed in claim 1, wherein,
the difference types and/or the assigned simulator variants are semantically specified by a knowledge graph.

9. The method as claimed in claim 1, wherein,
a sensitivity of a respective operating state to a respective operating signal is ascertained,
the ascertained sensitivities are taken as a basis for selecting a group of operating states, and
detection of the difference is limited to the group of selected operating states.

10. An assembly for monitoring or controlling a machine, configured to carry out a method as claimed in claim 1.

11. A computer program product, comprising a computer readable hardware storage device having a computer readable program code stored therein, the program code executable by a processor of a computer system to implement the method as claimed in claim 1.

12. A computer-readable storage medium comprising a computer program product as claimed in claim 11.
